(19) United States
(12) Patent Application Publication
(10) Pub. No.: US 2015/0142696 A1
(43) Pub. Date: May 21, 2015

(54) Investment management system accuracy increasing method

(71) Applicant: Anton Issinski, Coquitlam (CA)

(72) Inventor: Anton Issinski, Coquitlam (CA)

(21) Appl. No.: 13/950,307

(22) Filed: Jul. 25, 2013

(51) Int. Cl. G06Q 40/06

(52) U.S. Cl. CPC G06Q 40/06
USPC 705/36 R

(57) ABSTRACT

A method of improving investment performance models accuracy by taking into the account the effects of model optimization process that leads to systematic calculation errors caused by the limited amount of available historical investment data and a method of testing such systems that creates artificial historical investment data with known theoretical performance for such models. An investment management system comprising user interaction interface comprising a manual step of entering time independent investment algorithm, and automatic steps of performing all other necessary calculations leading to the production of real time portfolio management instructions.

### BACKGROUND OF THE INVENTION

The process of investment on stock markets usually is the process of calculating the amounts of stocks allocated in the investment portfolio.

In a simple approach, the amount of each stock is defined by two parameters: possible risk and possible profit that is associated with the stock. A mathematical formula that describes the particular amount of each stock can be derived from the Ito lemma that is well known in the statistics.

While estimating the risk in a first order is relatively well defined process that can for example use current volatility to calculate future statistical deviation, estimating the profit always requires an individual decision from the investor. Various investment models entered into computer systems are often used to assist in making such decisions.

Once a model is entered in to the computer system, a next step one can do is to check how the model would perform if it would be used in the past. This gives an estimate of what to expect from the model in the future and answers the question about possible profit, required to calculate the amount of stock optimum in the portfolio.

It is reasonable to expect that a model that performed better on large amount of historical data in the past will also perform better in the future. Hence the second step would be to make changes to the selected model or choose another model, so the profit from it on the historical data will become higher. This process of modifying model or selecting a better one is further referenced here as process of optimization and the new modified or selected model is called optimized model. Such optimized model is then used in the portfolio management process, including process of estimating expected profits.

### BRIEF SUMMARY OF THE INVENTION

This invention identifies that the process of optimization introduces a bias into model output values. Such bias should be corrected by calibration or other means to improve model accuracy. The model itself can be used to generate a special set of artificial historical data with known theoretical output values to test and calibrate the optimization procedures.

Furthermore, to simplify the above investment process, the interaction between the investor and the investment management system should be reduced to the process of entering of time-independent investment algorithm while delegating the rest of the steps as a common knowledge to the automatic management system.

### DETAILED DESCRIPTION OF THE INVENTION

The first claim of this invention declares that models optimized on finite set of historical data are not accurately representing the expected future values and should be modified to eliminate the bias introduced by the optimization process.

Because of the limited amount of available historical samples, the performance of the optimized model on historical data will be better than the performance on the future data, where optimization was not performed. Depending on the complexity of the model, computation speed and accuracy required, the correct performance can be obtained by analytical elimination of the bias, calibration (claim 2), or other methods.

For example, optimizing and calculating model performance on a randomly generated historical investment data will calculate the bias value that can be used for zero calibration, which is widely used in measurement practices.

The third claim is related to the testing process of the investment management system. The optimization of complex models, especially the ones that have non-linear dependence on its optimization parameters, may or may not lead to the correct results. After just performing numerical optimization of the model and correcting its predictions according to the claim 1, it may be still uncertain that the results are statistically accurate and free from any other errors such as software or implementation errors. Separate tests should be done to check the relevance of the results.

According to the claim 3, first a set of artificial historical investment data is created. The actual performance of the optimized model on such data is known because of the way the historical data is constructed. Second, the investment management system is run against such artificially constructed historical data and the obtained performance results are compared to the known theoretical ones.

Claim 4 describes a method of simplification of interaction between the investor and the investment management system. It also increases the accuracy of the investment process by ensuring that all necessary steps are taken into the account.

The above methods of proper calculation of portfolio management instructions may sound complicated to an investor who is not very familiar with the mathematical and numerical aspects of investment process. However, the only unique aspect of the investment process related to the particular investor is the algorithm (1.1) of claim 4, by which the future values like future stock price change rates are calculated. All other aspects of the investment process like selecting historical data, optimizing the model, testing and creating real time portfolio management instructions are common and should be hidden from the investor and delegated to the computer system.

According to the claim 4, the investment management system should look like a black box for the investor that takes the algorithm as the input, does all necessary processing described above and returns the portfolio management instructions as the output.

Such instructions can be further forwarded to the exchange or a broker for execution, making the investment process essentially the algorithm (1.1) of claim 4 development process.

1. An investment management system comprising of:
1. An algorithm that for a given set of some investment data that can be observed at some historical or present moment M1 used as an input creates an output data Out(M1) which:
1.1 Estimates investment data that can be observed at a moment M2 that comes after the moment M1,
2. Variables, methods or decisions used in the algorithm (1), referred further here as optimization parameters,
3. A process of choosing optimization parameters (2) from some set to improve the estimation (1.1) accuracy of the output data Out(M) of the said algorithm (1) on some:
3.1 Finite set of historical investment data samples,
4. Systematic estimation (1.1) calculation error introduced by the above process (3) of choosing optimization parameters as the result of limited amount of available statistical samples (3.1) and finite non-zero amount of optimization parameters (2),
5. A method of reducing said systematic calculation error (4).

2. A method of claim 1 where the method (5) of reducing systematic calculation error is a calibration method.

3. Investment management system testing method comprising of:
1. Investment management system comprising of:
1.1 An algorithm that for a given set of some investment data that can be observed at some historical or present moment M1 used as an input creates an output data Out(M1) which estimates investment data that can be observed at a moment M2 that comes after the moment M1 ,
2. A method of creating artificial historical investment data consisting of steps of:
2.1 Taking some real, artificial or random investment data at some historical moment M1,
2.2 Using it as an input for the algorithm (1.1) to create some output data Out(M1),
2.3 Creating an artificial historical investment data for a historical moment M2 that comes after the moment M1, using Out(M1).
3. A method of testing of some algorithm satisfying (1.1) using a set of artificial historical data obtained by method (2).

4. An investment management system comprising of:
1. A user input interface to enter:
1.1 An algorithm that for a given set of some investment data that can be observed at some historical or present moment M1 used as an input creates an output data Out(M1) which:
1.1.1 Estimates investment data that can be observed at a moment M2 that comes after the moment M1 ,
2. Variables, methods or decisions used in the algorithm (1.1), referred further here as optimization parameters,
3. A process of obtaining or getting access to some set of historical investment data,
4. A process of choosing optimization parameters (2) from some set to improve the estimation (1.1.1) accuracy of the output data Out(M) of the said algorithm (1.1) on some set of historical investment data samples from (3),
5. A process of obtaining or getting access to the present time set of investment data that is required as an input for the algorithm (1.1) to estimate investment data that can be observed in the future,
6. A method of obtaining portfolio management output instructions by:
6.1 Applying algorithm (1.1) that uses optimization parameters (2) obtained by process (4) on a set of present time investment data (5), to estimate investment data that can be observed in the future, and
6.2 Calculating portfolio management instructions using said investment data estimates of (6.1).
